(19) United States
(12) Patent Application Publication
(10) Pub. No.: US 2026/0266732 A1
(43) Pub. Date: Sep. 10, 2026

(54) FLAME-BASED DETECTORS WITH PROTECTED IGNITOR

(71) Applicant: Agilent Technologies, Inc., Santa Clara, CA (US)

(72) Inventors: Fei-Peng GUO, Shanghai (CN); Wei-Jun YAO, Shanghai (CN); Ting ZHANG, Shanghai (CN); Kaike Kevin ZHU, Shanghai (CN)

(73) Assignee: Agilent Technologies, Inc., Santa Clara, CA (US)

(21) Appl. No.: 19/166,851

(22) PCT Filed: Mar. 20, 2023
(86) PCT No.: PCT/CN2023/082510

§ 371 Date: Sep. 18, 2025

(51) Int. Cl. G01N 21/72; F23Q 7/10; F23Q 7/22

(52) U.S. Cl. CPC G01N 21/72; F23Q 7/10; F23Q 7/22

(57) ABSTRACT

Flame-based detectors having an ignitor are protected from corrosion by flowing a protective gas over the ignitor. The protective gas layer protects the ignitor from corrosive components in exhaust gas.

### CROSS-REFERENCE TO RELATED APPLICATIONS

None.

### FIELD OF THE INVENTION

The present invention relates generally to flame-based detectors and methods of manufacturing and using such detectors.

### BACKGROUND OF THE INVENTION

Flame-based detectors are used for the detection of analytes of a sample that are present in a fluid stream. Two such detectors are the flame ionization detector (FID) and the flame photometric detector (FPD).

Flame ionization detectors operate by burning the analytes to be analyzed so as to form ions. When used with a chromatography analytical instrument, the sample analytes eluting from a separation column are mixed with a flammable gas such as hydrogen and passed through a burner. Air is also introduced at the periphery of the burner, and upon the burner being ignited, a stable flame is formed by combustion of the fuel and air which continues to be supplied to the burner. An electrode or other ion collector is positioned downstream from the burner so as to collect the ions formed in the flame. A meter is connected with the ion collector to measure changes in current produced by the ions contacting the ion collector. The generation of these ions is proportional to the concentration of organic species in the sample introduced to the FID.

Flame photometric detectors operate in a fashion similar to that of the flame ionization detector but rely on chemiluminescent reactions of analytes rather than ionization reactions. Typically, a FPD is used to detect the presence of sulfur or phosphorus in a sample. Like the FID, the FPD mixes a sample with a flammable fuel and air in a flame, and analytes like sulfur and phosphorus are transformed into light emitting species when burned in the flame. Rather than collecting ions, the FPD collects light emitted by the analytes as they luminesce in the flame. A photomultiplier is positioned in the FPD to collect light (photons) emitted as the analytes burn in the flame, and the light emission from the excited chemical species can be used to determine analyte concentration and to quantify the concentration of a particular excited species. FPDs often incorporate a photomultiplier tube (PMT) to measure the number of photons and thus the intensity of light emitted from phosphorus and sulfur containing compounds, with wavelength selective filters disposed between the flame of the FPD and the PMT.

U.S. Pat. No. 4,346,055 discloses a flame-ionization detector in which the ignitor is mounted above a collector body that is downstream from the jet. When the hydrogen-air gas reaches the hot filament at a suitable concentration, it is ignited. However, a disadvantage of that device is that the FID exhaust gas can contain corrosive substances, such as sulfide from analyzed sample, and the exhaust gas can corrode the solder joint between the hot filament and the wire of the ignitor, which leads to high circuit resistance or an open circuit. This can cause the flame to fail to ignite.

Ignition of the burner may be complicated by various conditions of the device or the procedure. Furthermore, the operator is typically unaware of all the conditions that are present during the attempt at ignition, thus compounding the difficulty of troubleshooting. If the device itself is in a marginal or unsuitable condition for ignition, the operator typically must make repeated attempts at ignition before successful ignition occurs and does so without knowledge of the reason why ignition is not successful, and therefore the ignition procedure can be significantly longer and more difficult than is desirable.

This can be even more bothersome during an attempt to re-ignite a detector during a flame-out condition that has arisen during an ongoing operation of the chromatograph. For example, the loss of a flame during an analytical run requires an immediate reignition in order to achieve a quick resumption of the operation of the detector. Otherwise, the results from a significant amount of the analytical run can be lost or compromised. There is a need to increase the reliability and ease of igniting the flame of a flame-based detector. There is also a need to reduce maintenance and increase the life of such detectors.

### SUMMARY OF THE INVENTION

As one aspect of the present invention, a flame-based detector (such as a FID or a FPD) is provided. The flame-based detector comprises a housing, a burner disposed within the upstream region of the housing, a fuel flow path for providing a flammable fuel to the burner; an air flow path for providing air to the burner; and an ion collector or a photon collector. The flame-based detector also comprises an ignitor in the downstream region of the housing, and a protective gas port upstream from the ignitor and configured to flow a protective gas over the ignitor.

As another aspect, detector systems are provided comprising a flame-based detector as described herein, a meter configured for measuring a signal from the collector, and a controller in signal communication with one or more other components of the detector system. The detector systems comprise an air source and/or a protective gas source fluidically connected to a protective gas port.

As yet another aspect, methods of operating a flame-based detector are provided. The method comprises igniting a flame in the flame-based detector, feeding a sample to the detector, and flowing a protective gas over the ignitor of the detector.

These and other features and advantages of the present devices and methods will be apparent from the following detailed description, in conjunction with the appended claims.

### BRIEF DESCRIPTION OF THE DRAWINGS

FIG. 1 is a cross-sectional drawing of a representative embodiment of the present flame-based detector.

FIG. 2 is a diagram of a representative embodiment of a detector system comprising the present flame-based detector.

The present teachings are best understood from the following detailed description when read with the accompanying drawing figures. The features are not necessarily drawn to scale. Wherever practical, like reference numerals refer to like features.

### DETAILED DESCRIPTION

The present flame-based detectors comprise a protective gas port mounted on a housing and configured to blow exhaust gas away from the ignitor at a time when ignition is not being performed. The protective gas port can create a protective gas layer that shields the ignitor, reducing the contact between solder joint and exhaust gas. The present flame-based detectors provide several advantages, such as reduced corrosion of its ignitor, reduced risk of an open circuit with the ignitor, and improved probability of successful ignition. Further, the useful life of the ignitor can be extended since the corrosion is slowed, which can reduce frequency of ignitor maintenance and replacement.

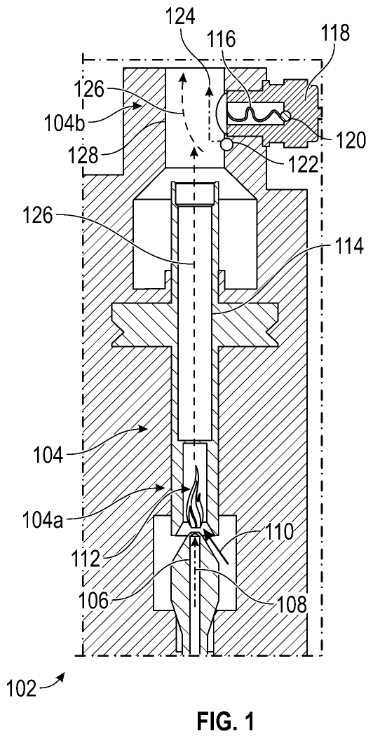

FIG. 1 shows a cross-section of an embodiment of the present flame-based detectors. More particular, FIG. 1 shows an exemplary flame ionization detector (FID) 102 though it will be understood that the flame photometric detector (FPD) can comprise many of the same components. The flame ionization detector comprises a housing 104 having an upstream region 104a and a downstream region 104b. The housing 104 can comprise one or more parts, such as two or more tubes in a fluid-tight connection. Suitable materials for the housing include stainless steel, titanium or other metals, metal alloys, ceramics, or combinations thereof.

The present flame-based detectors also comprise a burner 106 disposed within the upstream region of the housing. The burner can be made of a single unitary piece of material or from an assembly of burner components. The burner may be manufactured by machining, 3D printing, or cast molding. The material that may be used to manufacture the burner may be any metal, alloy, or polymer that is resistant to wear and may withstand high temperatures, such as a temperature of from about 200° C. to about 1000° C. For instance, the material may be a high-performance alloy with elements such as chromium, manganese, nickel, copper, titanium, molybdenum, silicon, columbium, tantalum, carbon, phosphorus, sulfur, nitrogen, iron, or a combination thereof. For example, the high-performance alloy may be a NITRONIC alloy commercially available from HP Alloys in Tipton, Ind.

The present flame-based detectors comprise a fuel flow path 108 for providing a flammable fuel to the burner. In most cases, the sample also flows through the fuel flow path 108 after exiting the column during an analysis, and it is contemplated that the fuel flow path is not limited to being a flow path only for fuel. The fuel can be hydrogen or a mixture of hydrogen and a diluent. The fuel flow path 108 can be integral with the burner 106, as shown in FIG. 1, or it may be a separate component. The present flame-based detectors comprise an air flow path 110 for providing air to the burner. The air flow path 110 can also be integral with the burner 106, or it may be a separate component. Air and fuel mix at the burner 106 to provide a flame 112.

The present flame-based detectors comprise a signal collector within the housing and extending from the upstream region to the downstream region. The signal collector may be an ion collector 114 in a FID or a photon collector in a FPD. Ion collectors are typically positioned adjacent to the flame generated by ignition of the air and fuel mixture at the burner. The ion collector can include one or more polarized electrodes which collect the ions produced as the sample passes through the flame. Collection of the ions causes an ionization current to flow. The current is proportional to the rate at which carbon atoms enter the flame and is therefore a measure of the concentration of hydrocarbons in the sample. The ion collector is electrically coupled to circuitry which extends through the housing, so that a signal can be transmitted. Information related to these concentrations may be stored for further analysis or output on a display device.

In some embodiments, the FID comprises a pair of positive and negative electrodes that are used to provide a potential difference in the FID. Typically, the burner acts as a positive electrode, and the negative electrode is the collector positioned above the flame. The ions thus are attracted to the collector and upon hitting the collector, induce a current which can be measured. The current measured corresponds roughly to the proportion of reduced carbon atoms in the flame. The response of the detector is determined by the number of carbon atoms (ions) hitting the detector per unit time. This makes the detector sensitive to the mass rather than the concentration, which is useful because the response of the detector is not greatly affected by changes in the carrier gas flow rate.

In some embodiments, the ion collector is made from stainless steel, titanium, tungsten, palladium, platinum or combinations thereof. The ion collector can have any suitable size or shape, including but not limited to tubes, cylinders, plates, or others.

The present flame-based detectors comprise an ignitor 116 in the downstream region 104b of the housing. The ignitor 116 can be any of a variety of ignitors that are able to ignite combustion of the combustible fuel supplied to the burner. In some embodiments, the ignitor comprises a filament such as a NiCr wire. The filament can be electrically connected to a power supply which may be the same or different than the power supply for other components of the detector. The ignitor can be within the housing, or it may be within an ignitor fitting 118 attached to the housing 104. The ignitor 116 can be connected by a solder joint 120 to the ignitor fitting 118 or to the housing 104.

The ignitor is used for initial ignition and re-ignition of the burner. A hot filament or other ignitor is mounted in the housing downstream from the burner. As the gases to be analyzed and the hydrogen emerge in the burner, they start mixing with air that is normally introduced around its periphery. When the gases reach the hot filament at the downstream region of the housing, they are combusted. The normal amount of gas flow is such that the resulting flame front is unable to propagate with sufficient speed to move upstream toward the burner. Therefore, the flow of one or more of the gases (usually the flow of air) is reduced. When the air-to-hydrogen ratio is sufficiently reduced, the flame front propagates at a sufficiently greater speed to move upstream in the slower moving gases and ignite the burner. At this point, the flow of air or other gas is increased to a rate desired for analysis and operation of the flame-based detector. Once the burner is lit, the flame generally remains in position, but should it flame out for any reason, the process is repeated.

Flame photometric detectors are ignited in a fashion similar to that of the flame ionization detector. However, because an FPD uses a flame that is substantially enriched with hydrogen rather than air, ignition in an FPD is typically aided by increasing the air flow, while the hydrogen flow is held constant.

After ignition of the burner, the ignitor need not be used again unless re-ignition is required, and generally does not need to be used during analysis of the sample. In some embodiments, the present flame-based detectors comprise a protective gas port 122 upstream from the ignitor 116 and configured to flow a protective gas over the ignitor. When the ignition is completed, the protective gas port is opened, and a protective gas 124 flows over the ignitor. In some embodiments, the protective gas is flowed over the ignitor whenever a sample is fed to the detector; for instance, the protective gas port can be opened and the protective gas can begin flowing for a lead time period before the sample is fed to the detector, such as at least 1 second, or at least 5, 10, 30, or 60 seconds; alternatively or additionally, the protective gas port can be closed and the protective gas can stop flowing for a lag time period after stopping the feed of the sample to the detector, such as at least 30 seconds, or at least 1, 2, or 5 minutes.

In some embodiments, the protective gas port is opened, and a protective gas flows over the ignitor when a sample comprising, or suspected of comprising, a corrosive substance is being fed to the detector. For example, when a sample contains sulfur, chlorine or other substances that burn and produce acidic, alkaline or corrosive substances, the exhaust gas 126 will corrode the filament of the ignitor 116 and/or the solder joint 120 connecting the ignitor to the flame-detector. The protective gas layer 124 can reduce the diffusion of the corrosive substance to ignitor 116. Meanwhile the air flow can blow the exhaust gas 126 away from ignitor 116, which can further reduce the diffusion. In some embodiments, the protective gas port is opened, and a protective gas flows over the ignitor only when a sample comprising, or suspected of comprising, a corrosive substance is being fed to the detector.

As illustrated in FIG. 1, the protective gas port 122 is disposed in the housing 104 of the detector 102, spaced sufficiently close to and upstream from the ignitor 116 to create a gaseous protective layer 124. In some embodiments, the protective gas port 122 has a shape that increases the area of the gaseous protective layer 124, such as an oval shape whose long axis is substantially perpendicular to the flow of the exhaust gas 126. The flame above the burner is maintained by the flow of combustible fuel and air. When the gasified sample is passed to the burner, it can be flame ionized. After passing through the ion collector, the exhaust gas 126 will pass by the ignitor 116 to the exhaust vent 128 of the detector 102. The gaseous protective layer blows the exhaust gas away from the ignitor and/or prevents essentially all of the exhaust gas, or a high percentage of the exhaust gas, from contacting the ignitor. In some embodiments, the pressure of the gaseous protective layer is from about 1 psi to about 10 psi, though the pressure may be increased or decreased based on the pressure of the exhaust gas or other considerations. In some embodiments, the flow of the gaseous protective layer is from about 50 ml/min to about 200 ml/min, though the flow may be increased or decreased based on the flow of the exhaust gas or other considerations.

The protective gas can be any gas, preferably a non-combustible gas. The protective gas is provided downstream of the collector so it will not interfere with the analysis or detection of the sample. In some embodiments, the protective gas is air. In such embodiments, the protective gas port can be fluidically connected to the same, or to a different, supply of air as the burner. In some embodiments, the protective gas is carbon dioxide (CO₂), nitrogen (N₂), argon (Ar), xenon (Xe), nitrous oxide (N₂O), helium (He), air or a chlorofluorocarbon (CFC), and the protective gas port can be fluidically connected to a source of such gases.

The protective gas port can be configured to promote laminar flow of the protective gas over the ignitor. The flame-based detectors can also comprise other features for forming or assisting in formation of the protective gas layer. In some embodiments, the flame-based detectors comprise one or more baffles adjacent to the protective gas port. The baffles can be positioned to direct or shape the flow of the protective gas exiting the protective gas port, and/or to confine or re-direct the protective gas over the ignitor.

In some embodiments, the present flame-based detectors comprise an exhaust vent 128 at the downstream region 104b of the housing 104 for exhaust gas 126 to leave the housing 104. The exhaust vent 128 can comprise an aperture that permits exhaust gas to flow out of the housing, or it may comprise one or more components such as valves, seals, fittings, or adaptors. In some embodiments, the exhaust vent 128 comprises a flame arrestor, which may be press fit into an aperture in the downstream region of the housing. Typical flame arrestors have sufficient heat conduction to remove heat from the flame as it attempts to travel through narrow passages. The detectors can also comprise an exhaust fitting which facilitates connection of a conduit or other vessel for collecting the exhaust gas.

### Detector Systems

As another aspect, the present disclosure provides detector systems comprising the present flame-based detectors and one or more connected components. For example, a detector system can comprise a controller operably connected to a flame-based detector so as to control flow of the sample, the combustible fuel and/or the air, such as by operation of one or more valves between the respective gas supplies and the flame-based detector. The detector systems can further comprise valves, flow regulators, conduits and other components between the respective gas supplies and the flame-based detector. As an example, an embodiment of a detector system comprises various gas sources, fluid delivery components, a power source and/or voltage differential source, a vacuum source, as well as various meters and sensors. As used herein, gas sources include containers (such as cannisters or tanks) filled with the gas, which may be pressurized or unpressurized. For example, a fuel source can be a tank of pressurized hydrogen gas. Gas sources also include panels connected to a gas distribution system such as those typically found in laboratories. The sample source will generally be or comprise a flow path from a chromatography column.

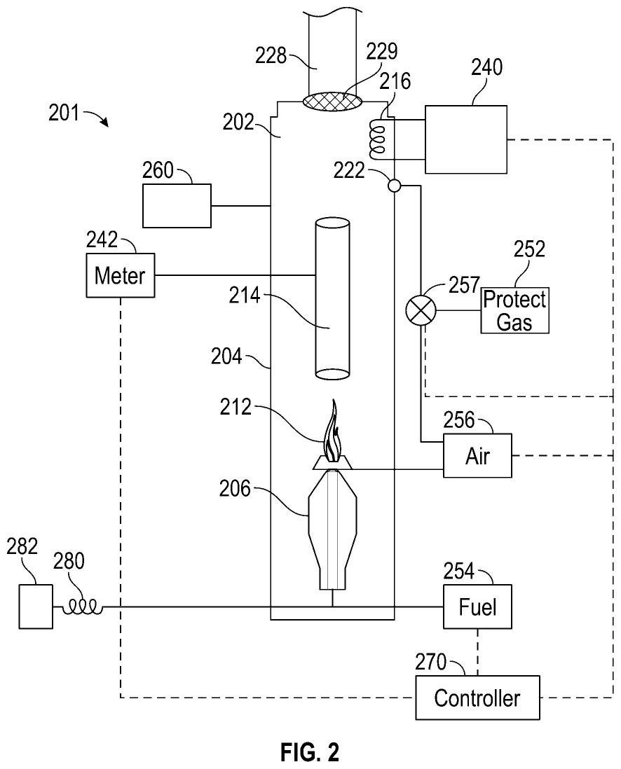

FIG. 2 illustrates an embodiment of a detector system 201 comprising a flame-based detector 202 comprising a housing 204, a burner 206, and an ion collector 214. A flame 212 is ignited over a burner 206, and ions pass through ion collector 214, which is electrically connected to a meter 242 (such as a high-impedance picoammeter) capable of measuring ions collected by collector 214, by one or more electrical contacts which extend through housing 204. An ignitor 216 is mounted on an interior wall of housing 204 or it may be within an ignitor fitting, and is electrically connected to a current source 240 so that an electrical current can be provided to ignitor 216 when it is desired to heat it to a combustion temperature. Flame-based detector 202 also comprises an exhaust vent 228 and a flame arrestor 229. The detector system can also comprise a controller 270 in signal communication with one or more other components of the detector system.

Protective gas port 222 is fluidically connected to a protective gas source 252, with a protective gas valve 257 which can be operated to start, stop, increase or decrease flow of the protective gas. In the embodiment shown in FIG. 2, the protective gas port 222 can receive air from air source 256 and/or a protective gas from 252 by operation of protective gas valve 257. It is also contemplated that air from air source 256 is employed as the protective gas; that is, the same air source 256 which provides air to burner 206 also provides air to protective gas port 222, and as a consequence, the detector system need not include a separate protective gas source. Alternatively, where detector system 201 includes a protective gas source 252, the air source 256 for the burner 206 need not be fluidically connected to protective gas port 222. The protective gas source 252 in such embodiments may be air or another gas. In embodiments, where the protective gas is not air, the protective gas source 252 can contain carbon dioxide (CO₂), nitrogen (N₂), argon (Ar), xenon (Xe), nitrous oxide (N₂O), helium (He) or a chlorofluorocarbon (CFC). In some embodiments, the detector system comprises a make-up gas supply, and the make-up gas is also used as the protective gas; in such embodiments, the make-up gas supply is fluidically connected to the protective gas port.

Controller 270 can be one or more computing devices, for example, a computer such as a personal computer, and can include one or more types of hardware, firmware and/or software, as well as one or more memories and databases. Controller 270 is in signal communication with other systems, devices, or components of the detector system 201 (as partially represented, for example, by dashed lines in FIG. 2). More particularly, in FIG. 2, controller 270 is in signal communication with meter 242, protective gas source 252 or the protective gas valve 257, and current supply 240. Controller 270 is also in signal communication with air source 256, fuel source 254, or with valves connected to and controlling flow from such sources. In some embodiments, controller 270 can be in communication with additional components or fewer components.

The detector system can comprise a source of flammable fuel 254, a source of air 256, eluted sample(s) from chromatographic column 280, a metering system, and a variety of other components. Each gas source can comprise a metering system that can meter each of hydrogen 254, air 256 and/or eluted sample(s) 258 into specific amounts prior to providing the mixture to burner 206. Additionally, a metering system can also combine the metered hydrogen, air and/or eluted sample(s) into specific mixtures prior to delivering the samples to burner 206. For example, metering system can meter and combine hydrogen 254 with the eluted sample(s) prior to providing the mixture to burner 206.

Controller 270 can be configured to receive data from the meter 242 and determine the concentration of ions as well as analytes in the sample based on the data. The manner in which the analyte is displayed can be selected by the manufacturer or user of the detector system 201, though often a graph is displayed that has time on the x-axis and detector response on the y-axis.

In some embodiments, the present flame-based detectors or detector systems are included in an analytical instrument, such as a chromatography analytical instrument. For example, the detector system 201 can be fluidically connected to a gas chromatography column 280. The chromatography analytical instrument can further comprise other chromatography components such as a sample injector 282, or an oven surrounding the chromatography column.

### Methods of Operating a Flame-Based Detector

As another aspect of the present invention, methods of operating a flame-based detector are provided, which protect the ignitor from corrosion and reduce maintenance frequency for the detector. The methods can comprise igniting a flame in the flame-based detector, and flowing a protective gas over the ignitor of the detector. In some embodiments, the method comprises igniting the flame before or while providing a sample to the flame-based detector. In some embodiments, the method comprises flowing protective gas over the ignitor whenever a sample is fed to the detector. The method can comprise flowing the protective gas for a lead time period before the sample is fed to the detector, as described above; alternatively or additionally, the method can comprise continuing the flow of the protective gas for a lag time period after stopping the feed of the sample to the detector.

### Defined Terms

It is to be understood that the terminology used herein is for purposes of describing particular embodiments only and is not intended to be limiting. The defined terms are in addition to the technical and scientific meanings of the defined terms as commonly understood and accepted in the technical field of the present teachings.

The term “connected” means that two components are fluidically connected, or physically connected, or both. The term “fluidically connected” means that two components are in fluid communication and includes direct connections between the two components as well as indirect connections where one or more other components are in the flow path between the two components. For example, a first component and a second component are fluidically connected if an outlet from the first component is physically connected to an inlet of the second component, or if a conduit connects the first and second components, or if one or more intervening components, such as a valve, a pump, or other structure, is between the two components as fluid flows from the first component to the second component, or vice versa. Components can be physically connected in any suitable way, such as by using ferrules, brazing, and other approaches. In general, physical connections that are fluid-tight and/or that minimize dead-volume are desired for the present devices.

Two or more systems, devices, or components are in “signal communication” when they are capable of communicating with each other via signals that travel over some type of signal path. The signal paths may include physical, electrical, magnetic, electromagnetic, electrochemical, optical, wired, or wireless connections. The signal paths may also include additional systems, devices, or components.

The term “flow path” generally refers to any structure configured to provide for fluid flow. The flow path may be a tube or a channel formed in a substrate. A flow path may be formed by or comprise one or more tubes or channels in fluid communication. A flow path typically has an entrance and an exit, though in some embodiments, a flow path can have multiple entrances and/or exits. The geometry of a flow path may vary widely and includes circular, rectangular, square, D-shaped, trapezoidal or other polygonal cross-sections. A flow path may comprise varying geometries (e.g., rectangular at one section and trapezoidal at another section). In some embodiments, the cross-sectional area of a flow path is substantially constant.

The term “port” encompasses any opening or structure that permits a fluid to pass, including an inlet, an outlet, a conduit, or an aperture or other opening. The term “conduit” generally encompasses any structure such as tubing that defines a flow path for fluid to travel from one point (e.g., an inlet of the conduit) to another point (e.g., an outlet of the conduit), though a conduit can deliver fluid to intermediate points as well. A conduit can be flexible, rigid, or both in some measure or portions. Typically a conduit is relatively long and/or linear and provides a flow path from one component (such as a gas source) to another component.

In the present disclosure, the terms “substantial” or “substantially” mean to within acceptable limits or degree to one having ordinary skill in the art. The terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same. When a range of values is set forth in the present disclosure, it should be understood that each intervening value, to the tenth of the unit of the lower limit, unless the context clearly dictates otherwise, between the upper and lower limits of that range is also specifically disclosed. Each smaller range between any stated value or intervening value in a stated range and any other stated or intervening value in that stated range is encompassed within the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described. All patents and publications referred to herein are expressly incorporated by reference.

As used in the specification and appended claims, the terms “a,” “an,” and “the” include both singular and plural referents, unless the context clearly dictates otherwise. Thus, for example, “a component” includes one component and plural components. The terms “first” and “second” conduits (or other “first” and “second” elements) are terms to distinguish different elements, not terms supplying a numerical limit, and a device having first and second element can also include a third, a fourth, a fifth, and so on, unless otherwise indicated.

In view of this disclosure, it is noted that the present methods can be implemented in keeping with the present teachings. Further, the various components, materials, structures and parameters are included by way of illustration and example only and not in any limiting sense. In view of this disclosure, the present teachings can be implemented in other applications and components, materials, structures and equipment to implement these applications can be determined, while remaining within the scope of the appended claims.

### Exemplary Embodiments

Exemplary embodiments provided in accordance with the presently disclosed subject matter include, but are not limited to, the following:

Embodiment 1. A flame-based detector comprising: a housing having an upstream region and a downstream region; a burner disposed within the upstream region of the housing; a fuel flow path for providing a flammable fuel to the burner; an air flow path for providing air to the burner; a collector within the housing, wherein the collector is an ion collector or a photon collector; an ignitor in the downstream region; a protective gas port upstream from the ignitor and configured to flow a protective gas over the ignitor; and an exhaust vent at the downstream region of the housing for discharging exhaust gas from the housing.

Embodiment 2. The flame-based detector of embodiment 1, wherein the protective gas port has an oval shape.

Embodiment 3. The flame-based detector of embodiment 1 or 2, wherein the ignitor is a filament mounted within or downstream of the collector tube.

Embodiment 4. The flame-based detector of embodiment 3, further comprising an ignitor fitting connected to the housing, and the filament is inside the ignitor fitting.

Embodiment 5. The flame-based detector of embodiment 4, wherein the filament is soldered to the housing or an ignitor fitting.

Embodiment 6. The flame-based detector of any of embodiments 1 to 5, wherein the protective gas port is configured to promote laminar flow of the protective gas over the ignitor.

Embodiment 7. The flame-based detector of any of embodiments 1 to 6, wherein the burner comprises a nozzle for forming a jet comprising fuel and air.

Embodiment 8. The flame-based detector of any of embodiments 1 to 7, wherein the nozzle comprises an outer nozzle surface and an inner nozzle bore, and the fuel flow path is the inner nozzle bore, and the air flow path introduces air to the outer nozzle surface.

Embodiment 9. The flame-based detector of any of embodiments 1 to 8, wherein the collector is an ion collector.

Embodiment 10. The flame-based detector of embodiment 9, wherein the ion collector is a collector tube having one end positioned in the upstream region to receive ions from the burner and an opposite end positioned in the downstream region for exhausting gas from the collector tube.

Embodiment 11. The flame-based detector of any of embodiments 1 to 8, wherein the collector is a photon collector.

Embodiment 12. The flame-based detector of embodiment 11, wherein the flame-based detector comprises a photomultiplier tube (PMT).

Embodiment 13. A detector system comprising a flame-based detector according to any of embodiments 1 to 12, and a meter configured for measuring a signal from the collector, and a controller in signal communication with one or more other components of the detector system.

Embodiment 14. The detector system of embodiment 13, further comprising a flammable fuel source fluidically connected to the fuel flow path, and an air source fluidically connected to the air flow path.

Embodiment 15. The detector system of embodiment 13, wherein the air source is fluidically connected to the protective gas port.

Embodiment 16. The detector system of embodiment 13 or embodiment 14, further comprising a protective gas source fluidically connected to the protective gas port.

Embodiment 17. The detector system of any of embodiments 13 to 16, further comprising a protective gas valve in signal communication with the controller and fluidically connected to the air source and/or the protective gas source.

Embodiment 18. A method of operating a flame-based detector according to any of embodiments 1 to 12, the method comprising: igniting a flame in the flame-based detector, feeding a sample to the detector, and flowing a protective gas over the ignitor of the detector.

Embodiment 19. The method of embodiment 18, wherein the protective gas is flowed over the ignitor whenever a sample is fed to the detector.

Embodiment 20. The method of embodiment 18, wherein the protective gas is flowed when a sample contains sulfur, chlorine or other substances that burn and produce acidic, alkaline or corrosive substances.

Embodiment 21. The method of embodiment 18, wherein the method further comprises flowing the protective gas for a lead time period before the sample is fed to the detector, and/or continuing the flow of the protective gas for a lag time period after stopping the feed of the sample to the detector.

Embodiment 22. The method of embodiment 21, wherein the lead time period is at least 1 second.

Embodiment 23. The method of embodiment 21, wherein the lag time period is at least 30 seconds.

Embodiment 24. The method of embodiment 18, wherein the protective gas is flowed through the protective gas port at a flowrate of from about 50 ml/min to about 200 ml/min.

Embodiment 25. The method of any of embodiments 18 to 24, wherein the protective gas is selected from the group consisting of air, carbon dioxide (CO2), nitrogen (N2), argon (Ar), xenon (Xe), nitrous oxide (N2O), helium (He), air, a chlorofluorocarbon (CFC), and mixtures thereof.

Embodiment 26. The method of any of embodiments 18 to 25, wherein the protective gas port receives air from air source and/or a protective gas from a protective gas source and/or make-up gas from a make-up gas source.

The foregoing descriptions of exemplary or preferred embodiments should be taken as illustrating, rather than as limiting the present invention as defined by the embodiments. As will be readily appreciated, numerous variations and combinations of the features set forth above can be utilized without departing from the present invention as set forth in the embodiments. Such variations are not regarded as a departure from the scope of the invention, and all such variations are intended to be included within the scope of the following embodiments. All references cited herein are incorporated by reference in their entireties.

We claim:

1. A flame-based detector comprising:
a housing having an upstream region and a downstream region;
a burner disposed within the upstream region of the housing;
a fuel flow path for providing a flammable fuel to the burner;
an air flow path for providing air to the burner;
a collector within the housing, wherein the collector is an ion collector or a photon collector;
an ignitor in the downstream region;
a protective gas port upstream from the ignitor and configured to flow a protective gas over the ignitor; and
an exhaust vent at the downstream region of the housing for discharging exhaust gas from the housing.

2. The flame-based detector of claim 1, wherein the protective gas port has an oval shape.

3. The flame-based detector of claim 1, wherein the ignitor is a filament mounted within or downstream of the collector tube.

4. The flame-based detector of claim 3, further comprising an ignitor fitting connected to the housing, and the filament is inside the ignitor fitting.

5. The flame-based detector of claim 4, wherein the filament is soldered to the housing or an ignitor fitting.

6. The flame-based detector of claim 1, wherein the protective gas port is configured to promote laminar flow of the protective gas over the ignitor.

7. The flame-based detector of claim 1, wherein the burner comprises a nozzle for forming a jet comprising fuel and air.

8. The flame-based detector of claim 1, wherein the nozzle comprises an outer nozzle surface and an inner nozzle bore, and the fuel flow path is the inner nozzle bore, and the air flow path introduces air to the outer nozzle surface.

9. The flame-based detector of claim 1, wherein the collector is an ion collector.

10. The flame-based detector of claim 9, wherein the ion collector is a collector tube having one end positioned in the upstream region to receive ions from the burner and an opposite end positioned in the downstream region for exhausting gas from the collector tube.

11. The flame-based detector of claim 1, wherein the collector is a photon collector.

12. The flame-based detector of claim 11, wherein the flame-based detector comprises a photomultiplier tube (PMT).

13. A detector system comprising a flame-based detector according to claim 1, and a meter configured for measuring a signal from the collector, and a controller in signal communication with one or more other components of the detector system.

14. The detector system of claim 13, further comprising a flammable fuel source fluidically connected to the fuel flow path, and an air source fluidically connected to the air flow path.

15. The detector system of claim 14, wherein the air source is fluidically connected to the protective gas port.

16. The detector system of claim 13, further comprising a protective gas source fluidically connected to the protective gas port.

17. The detector system of claim 13, further comprising a protective gas valve in signal communication with the controller and fluidically connected to an air source and/or a protective gas source.

18. A method of operating a flame-based detector according to claim 1, the method comprising:
igniting a flame in the flame-based detector,
feeding a sample to the detector, and
flowing a protective gas over the ignitor of the detector.

19. The method of claim 18, wherein the protective gas is flowed over the ignitor whenever a sample is fed to the detector.

20. The method of claim 18, wherein the protective gas is flowed when a sample contains sulfur, chlorine or other substances that burn and produce acidic, alkaline or corrosive substances.
